(19) United States
(12) Patent Application Publication
(10) Pub. No.: US 2004/0000863 A1
(43) Pub. Date: Jan. 1, 2004

(54) Electroluminescence display device

(75) Inventor: Takako Miyake, Tsurugashima-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/408,652

(22) Filed: Apr. 8, 2003

(30) Foreign Application Priority Data
Apr. 9, 2002 (JP) 2002-105969

(51) Int. Cl. H05B 33/00

(52) U.S. Cl. 313/501; 313/504

(57) ABSTRACT

An electroluminescence display device includes a planar plate having a characteristic of restricting outdoor light reflection, and one or more electroluminescence elements on the planar plate. The characteristic of restricting outdoor light reflection includes at least one of polarization, anti-reflection, anti-glare and shading. Since the planar plate reduces the outdoor light reflection, it is possible to prevent contrast deterioration of a displayed image.

### BACKGROUND OF THE INVENTION

1. Field of the Invention

The present invention relates to an electroluminescence (referred to as an “EL” hereinafter) display device.

2. Description of the Related Art

Inorganic or organic EL elements are self light emitting elements and are used for display devices. In general, the EL elements are arranged in a matrix fashion when used for the display devices. The EL elements are formed by laminating a transparent electrode on a light-transmissive substrate, a light emission layer on the transparent electrode, and a metallic electrode on the light emission layer.

If the EL display device is utilized in a bright place such as outdoors, the outdoor light (outside light) or bright light is reflected by the light-transmissive substrate and metallic electrode. Therefore, light deriving from an image displayed by the display device and the reflected light of the outdoor light overlap. This deteriorates contrast of the displayed image.

### SUMMARY OF THE INVENTION

An object of the present invention is to provide an EL display device that can prevent the deterioration in contrast of a displayed image when the EL display device is used in a bright place.

According to one aspect of the present invention, there is provided an electroluminescence display device including a planar plate having a characteristic for restricting outdoor light reflection, and one or more electroluminescence elements on the planar plate. The characteristic for restricting outdoor light reflection includes at least one of polarization, anti-reflection, anti-glare and shading. Since the planar plate reduces the outdoor light reflection, it is possible to prevent contrast deterioration of a displayed image.

### BRIEF DESCRIPTION OF THE DRAWINGS

FIG. 1 illustrates a cross sectional view of an EL display device according to one embodiment of the present invention;

FIG. 2 illustrates a cross sectional view of an EL display device according to another embodiment of the present invention, with a resin substrate being used as a planar plate; and

FIG. 3 illustrates a cross sectional view of still another embodiment of the present invention, with a partition wall being provided in an EL element.

### DETAILED DESCRIPTION OF THE INVENTION

Embodiments of the present invention will be described with reference to the accompanying drawings.

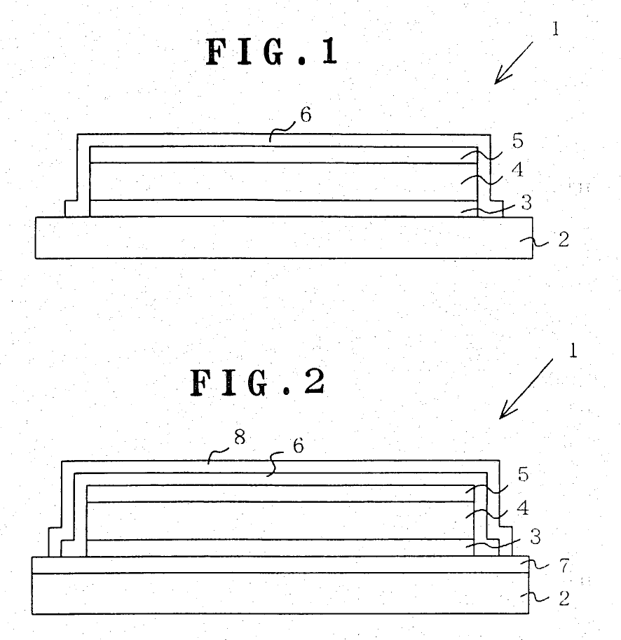

Referring to FIG. 1, an EL display device includes a planar plate 2 and a plurality of EL elements 1 on the planar plate 2. The light emitting elements 1 are arranged on the planar plate 2 in a matrix fashion to form the EL display device. It should be noted that only one EL element 1 is illustrated in FIG. 1 for simplification and description purposes. The EL elements 1 have the same structure so that only the one illustrated EL element 1 is described in the following description. Each of the EL elements 1 of the EL display device includes a first element electrode (anode) 3 on the planar plate 2, a light emission layer 4, a second element electrode (cathode) 5 and a protection layer 6. These electrodes and layers are laminated on the planar plate 2 in the illustrated order. The planar plate 2 includes a glass substrate or a resin substrate, which transmits visible light therethrough. The planar plate 2 has a characteristic which acts to restrict reflection of outdoor light. The “outdoor light” includes any light having a brightness greater than a predetermined value. The restriction of the outdoor light reflection is achieved by polarization, anti-reflection, anti-glare or shading, or any combination of these methods.

The planar plate 2 may be provided with the polarization characteristic by, for example, a circular polarization filter film (plate) or a linear polarization filter film (plate). The circular polarization filter film is a quarter wave plate, and the linear polarization filter film is a liner polarization plate. It should be noted that a combination of the circular and linear polarization filter films can also be used for the planar plate 2. The two filter films may be adhered to each other.

The planar plate 2 having the anti-reflection characteristic is, for example, an anti-reflection film. The anti-reflection film may be provided by alternately laminating low-refractive-index layers and high-refractive-index layers (of film). The low-refractive-index layer has a predetermined (relatively low) refractive index, and the high-refractive-index layer has a refractive index higher than the predetermined refractive index.

The planar plate 2 may have the anti-glare characteristic, when the planar plate 2 has, for example, a thin film having very small concave and convex portions on a surface of the thin film. The minute recesses and bumps on the thin film may be created by chemical etching, grating or sand blasting. Such thin film is made from particles, that are organic material particles or inorganic material particles, or combination of the organic and inorganic material particles, and an organic material binder. The particles are dispersed uniformly in the thin film.

The planar plate 2 may have a shading characteristic when the planar plate 2 has, for example, an ND (neutral density) filter film that absorbs the incoming outdoor light to a certain extent. Preferably, the spectrum of the ND filter has a uniform transmittance over the entire visible light range in order to simply reduce the amount of incoming light, without changing the spectrum characteristic of the incoming light.

Alternatively, the planar plate provided with the shading characteristic may be a UV (ultraviolet) absorbing filter. The UV absorbing filter substantially absorbs the outdoor light in the UV range so that deterioration (e.g., discoloration) of the light emitting layer by the UV can be prevented.

Restriction of the outdoor light reflection is achieved by one of the polarization, anti-reflection, anti-glare and shading, or combination of any of these. For instance, the anti-glare film filter may be attached to the anti-reflection film to provide the planar plate 2. The planar plate 2 may then be provided with the anti-glare characteristic and the anti-reflection characteristic.

A functional film having the characteristic for restricting the outdoor light reflection may be coated over the glass substrate so as to provide the planar plate 2.

The first element electrode 3 is made of a conductive material, which transmits visible light. Specifically, the first element electrode 3 is made from a metal oxide (e.g., ITO) and/or a metal film (e.g., Au).

The light emission layer 4 is an inorganic or organic layer that emits light upon injection of electrons and/or holes. If the light emission efficiency of the light emission layer 4 is low, the hole injection layer and the electron transfer layer may sandwich the light emission layer 4.

The second element electrode 5 is made from a low-resistance material that includes a metallic material such as Al.

The protection layer 6 is made from SiNx having a moisture-proof characteristic. The protection layer 6 is formed over the entire EL element except for leads of the first and second element electrodes 3 and 5. It should be noted that the protection layer 6 may be dispensed with, if a sealing (encapsulating) can or any suitable container (not shown) houses the EL element 1.

FIG. 2 shows an organic EL element having a resin substrate as the planar plate 2. Similar reference numerals are used to designate similar parts in FIGS. 1 and 2.

As seen in FIG. 2, the EL element 1 includes the planar plate 2, a transparent moisture-proof layer 7, a first element electrode 3, a light emission layer 4, a second element electrode 5, a protection layer 6 and a hardcoat layer 8.

The planar plate 2 is a film made from a light transmissive resin. This resin film has a characteristic of restricting reflection of the outdoor light, and may be a circular polarization filter. The resin film may have some flexibility (can bend to a certain extent).

The transparent moisture-proof layer 7 is made from a transparent material (e.g., SiON) which prevents penetration of moisture. Since the planar plate 2 is a resin plate, water/moisture may penetrate the planar plate 2 and proceed towards the interior of the EL element 1. The moisture-proof layer 7 protects the EL element from such moisture/water. When the light emitting layer 4 is made from an organic material, the water-proof layer 7 prevents deterioration (i.e., generation of dark spots) of the light emitting layer 4 due to water/moisture.

The first element electrode 3 is a transparent electrode having a high transmittance (e.g., 90% or more) to the visible light. The light emitting layer 4 includes an organic-material layer that emits light upon injection of the holes and/or electrons. The second element electrode 5 is made from a low-resistance (e.g., about 0.2 Ω/cm² if the layer thickness is 1000 angstroms) metallic material. The protection layer 6 is made from SiNx which can prevent penetration of moisture.

The hardcoat layer 8 is made from a flexible organic material, such as UV curing resin. The hardcoat layer 8 imparts structural or mechanical rigidity to the EL element 1 and the EL display device.

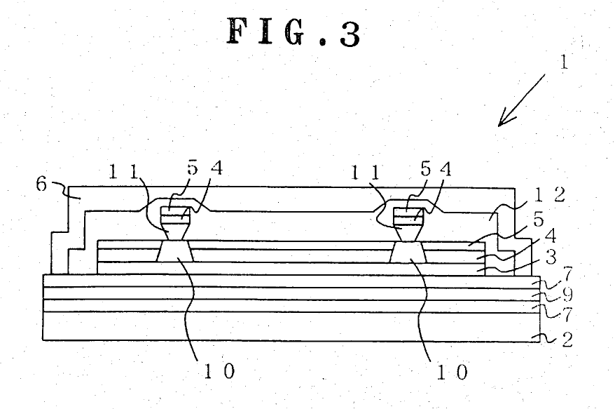

Referring to FIG. 3, another EL display device (third embodiment) is illustrated. Similar reference numerals are used to designate similar parts in FIGS. 2 and 3. The display device (or the EL element 1) shown in FIG. 3 is different from the display device shown in FIG. 2 in that two moisture-proof layers 7 are provided on the planar plate 2, with a resin layer 9 being interposed between the two moisture-proof layers 7. The second difference between FIGS. 2 and 3 lies in that an insulation layer 10 having a predetermined pattern is provided on the first element electrode 3, and a partition wall 11 projects upward from the insulation layer 10. The cross sectional shape of the insulation layer 10 is a trapezium. The cross sectional shape of the partition wall 11 is an inverted trapezium. The third difference is that the hardcoat layer 8 of FIG. 7 is omitted. The fourth difference is that a cushion layer 12 is provided between the second element electrode 5 and the protection layer 6. The insulation layer 10 is provided for covering an edge of the first element electrode (ITO) 3, and the partition wall 11 is provided for separating the second element electrode 5. Other elements in FIG. 3 are generally similar to those shown in FIG. 2.

The resin layer 9 is a layer made from a UV curing resin, and transmits the visible light therethrough. The resin layer 9 imparts the mechanical rigidity to the EL element 1 and the EL display device.

The insulation layer 10 is made from a metal oxide such as SiO2. The partition wall 11 is made from, for example, a photosensitive polymer that cures upon radiation of light thereto. The partition wall 11 is formed by taking advantage of a development speed difference resulting from an exposure difference in a thickness direction. The insulation layer 10 lies on the first element electrode 3 and defines a light emitting area of the EL element 1. The partition walls 11 extend in a direction perpendicular to the drawing sheet of FIG. 3 so that the partition walls 11 cross the first element electrode 3 at right angle. The two partition walls 11 are parallel to each other.

The cushion layer 12 extends over the partition wall 11 and the second element electrode 5. The cushion layer 12 is made from, for example, a UV curing resin.

It should be noted that the planar plate 2 may not be light-transmissive if the EL display device displays an image to a viewer via the planar plate 2.

This application is based on a Japanese patent application No. 2002-105969, and the entire disclosure thereof is incorporated herein by reference.

What is claimed is:

1. An electroluminescence display device comprising:
a planar plate having a characteristic which restricts outdoor light reflection; and
at least one electroluminescence element provided on the planar plate.

2. The electroluminescence display device according to claim 1, wherein the characteristic includes at least one of polarization, anti-reflection, anti-glare and shading.

3. The electroluminescence display device according to claim 1, wherein the planar plate includes a glass substrate.

4. The electroluminescence display device according to claim 1, wherein the planar plate includes a resin substrate.

5. The electroluminescence display device according to claim 1 further comprising a moisture proof film between the planar plate and the at least one electroluminescence element.

6. The electroluminescence display device according to claim 5, wherein the moisture proof film transmits visible light therethrough.

7. The electroluminescence display device according to claim 5, wherein each of the at least one electroluminescence element is an organic electroluminescence element.

8. The electroluminescence display device according to claim 5, wherein each of the at least one electroluminescence element is an inorganic electroluminescence element.

9. The electroluminescence display device according to claim 5, wherein each of the at least one electroluminescence element includes a first element electrode on the moisture-proof film, a light emission layer body on the first element electrode, a second element electrode on the light emission layer body, and a protection layer on the second element electrode, and the light emission layer body includes at least one light emitting layer.

10. The electroluminescence display device according to claim 9, wherein the protection layer is a moisture proof layer.

11. The electroluminescence display device according to claim 9 further comprising a hardcoat layer over the the protection layer.

12. The electroluminescence display device according to claim 1 further comprising two moisture proof films between the planar plate and the at least one electroluminescence element, and a resin layer interposed between the two moisture proof films.

13. The electroluminescence display device according to claim 12, wherein each of the at least one electroluminescence element includes a first element electrode on the two moisture proof films, a light emission layer on the first element electrode, a second element electrode on the light emission layer, and a protection layer on the second element electrode.

14. The electroluminescence display device according to claim 13 further comprising an insulation layer on the first element electrode and a partition wall on the insulation layer.

15. The electroluminescence display device according to claim 14 further comprising a cushion layer to cover the second element electrode, the partition wall, and the excluded part of the light emission layer and the second element electrode, the cushion layer extending below the protection layer.

16. The electroluminescence display device according to claim 1, wherein the characteristic of restricting outdoor light reflection is imparted to the planar plate by coating the planar plate with a layer or film having at least one of polarization, anti-reflection, anti-glare and shading characteristic.
